(19) United States
(12) Patent Application Publication
(10) Pub. No.: US 2006/0137538 A1
(43) Pub. Date: Jun. 29, 2006

(54) Conveying device for baked goods

(76) Inventor: Johann Anderl, Ludwigsburg (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/539,717

(22) PCT Filed: Dec. 3, 2003
(86) PCT No.: PCT/EP03/13611

§ 371 Date: Feb. 21, 2006

(30) Foreign Application Priority Data
Dec. 18, 2002 (DE) 202 19 697.6
Mar. 19, 2003 (DE) 103 12 141.2

(51) Int. Cl. A47J 37/08

(52) U.S. Cl. 99/386

(57) ABSTRACT

A conveying device for baked goods in which a conveying unit that is connected to a heating device is also connected to a supply device and to a removal device. A simple and compact design is obtained when the conveying unit has a helical surface which can be vibrated by a vibrating device and which is provided for conveying the baked goods upward. The supply device is connected in the lower area of the conveying unit, and the removal device is connected in the upper area of the conveying unit.

### BACKGROUND OF THE INVENTION

1. Field of the Invention

This invention relates to a conveying apparatus for baking products, where a conveying unit, which is connected to a heating device, is connected at one side to a supplying apparatus and at the other side to a removal apparatus.

2. Discussion of Related Art

Known conveying apparatuses for baking products are in the form, for example, of conveyor belts.

### SUMMARY OF THE INVENTION

It is one object of this invention to provide a conveying apparatus of the type mentioned above for conveying baking products, but so that the design is compact and simple and produces reliable conveying.

This object is achieved with a conveying apparatus as discussed in this specification and in the claims. A conveying unit of this invention includes a helical face that can be set to vibrate by an oscillating drive for conveying the baking products upwards, wherein the supplying apparatus is connected in the lower region of the conveying unit and the removal apparatus is connected in the upper region of the conveying unit.

The inclination of the helical face, in this case, can easily be selected in a suitable manner in order to obtain the desired conveying speed using the oscillating drive. The vibrations generated by the oscillating drive for the conveying can also be adapted in form and intensity to the desired conveying speed and also to the type of baking product.

In one embodiment of this invention, a hollow, more especially cylindrical central section is included in a recirculating air heating circuit which is conducted over the helical face, wherein the hot air is conducted downwards over the spirals and in the hollow central section the hot air flows upwards in order to heat the baking products in the desired manner.

In another embodiment, the helical face includes some steps, for example one after each 400°, wherein the steps are configured so that the baking products are turned when they exceed the step.

In one embodiment of the conveying unit, the oscillating drive includes two out-of-balance drive units, the force vectors of which are aligned, inclined to the vertical and inclined to each other. This design of the oscillating drive produces a relatively high degree of efficiency in a small model. In this case, relatively low frequencies and resultant low acceleration can be selected, and thus the drive can operate in a relatively quiet manner.

If the removal apparatus is disposed above the supplying apparatus on the same side of the conveyor unit, the arrangement is advantageous for operation when loading and unloading and the possibilities for the positioning of the apparatus are favorable.

The functioning and operating are favored if the supplying apparatus includes a supplying section, which is connected to the conveying unit and has a singling-out function, and a loading unit, which leads downwards to the supplying section and is set at an incline or is adjustable at an incline relative to the supplying section.

Additionally advantageous to the functioning for supplying the baking products, the supplying section and the loading unit are drivable by one common supplying drive or by separate supplying drives. Using these measures, the cold, uncooked baking products, which are often still frozen, are reliably conveyed from the loading unit to the supplying section and from the supplying section into the conveying unit.

If the supplying apparatus includes an individual loading section, which is connected to the supplying section, baking products can be introduced into a baking sequence according to the demands of the user.

Advantageous to the functioning and operating of the apparatus, the removal apparatus includes a removal section, which is connected to the upper end region of the helical face, and an output section, which leads inclinedly downwards to a removal apparatus.

In one embodiment that is advantageous to the operation of the apparatus, the heat of the baking products situated in the removal apparatus is conducted in part to the baking products situated in the supplying apparatus.

### BRIEF DESCRIPTION OF THE DRAWINGS

This invention is described in view of exemplified embodiments with reference to the drawings, wherein:

FIGS. 1A to 1C respectively show a front view, a side view from the left and a top view of an upper level of a first embodiment of a conveying apparatus for baking products with a removal apparatus, and FIG. 1D shows a top view of the same of a lower level with a supplying apparatus;

FIG. 2 shows a front view, a side view from the left and a top view of another embodiment of the conveying apparatus; and

FIG. 3 shows a cutout from a conveying unit as shown in FIGS. 1A to 1D and 2.

### DESCRIPTION OF PREFERRED EMBODIMENTS

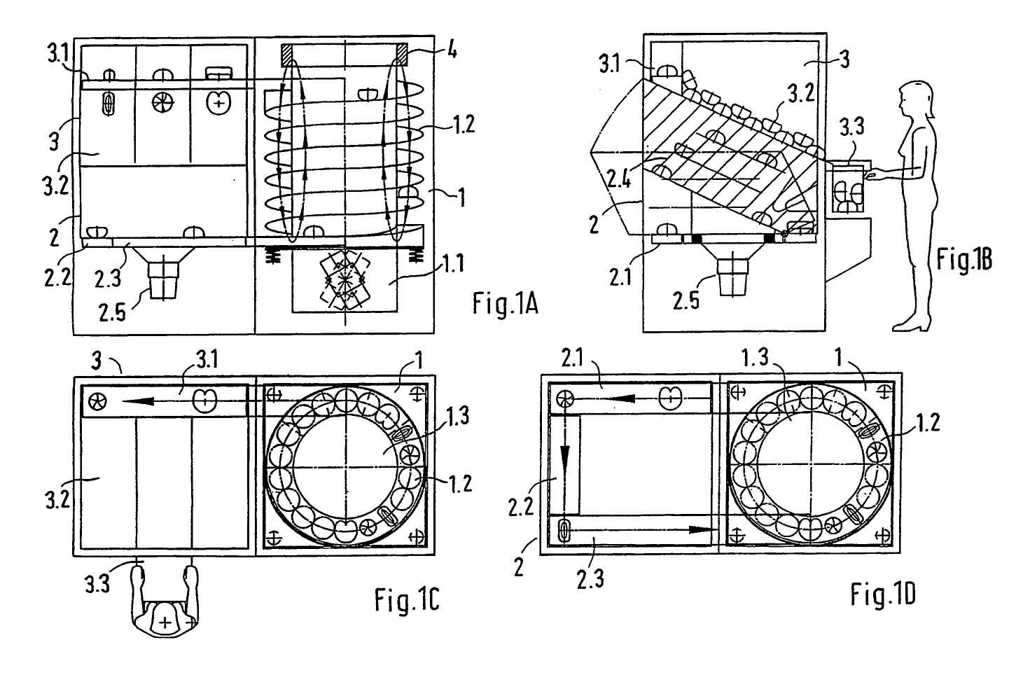

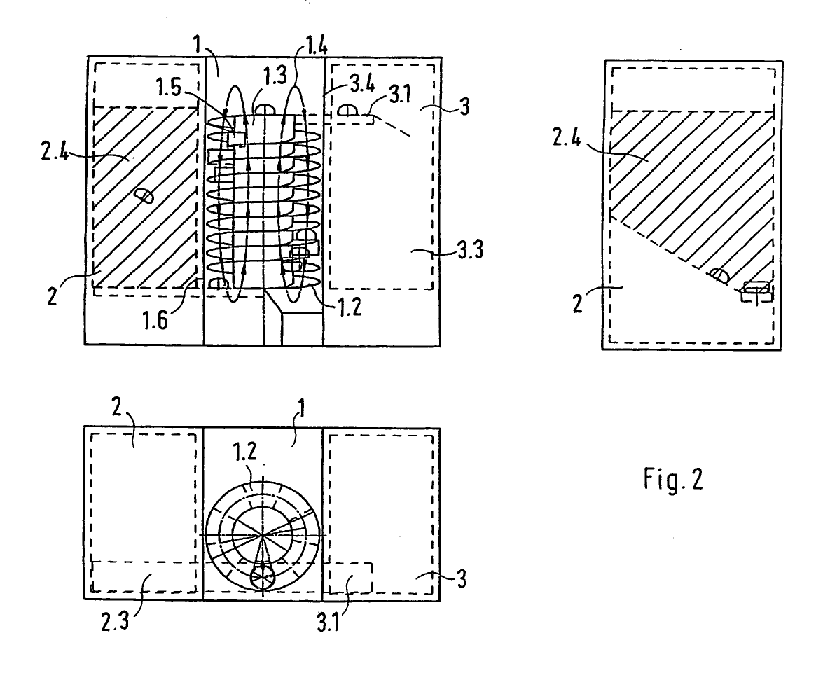

FIGS. 1A to 1D show four different views of a conveying device, respectively including a front view, a view from one supplying side, a top view of a lower supplying level, and a top view of an upper removal level. The baking products are supplied by a supplying apparatus 2 in the form of uncooked products into a chamber 1.6 in the conveying unit 1. The chamber 1.6 is disposed in the lower region of a conveying unit 1, and from this chamber the products are conducted further via another chamber 3.4 in the upper region, for example on the same side (FIGS. 1A to 1D) or on the oppositely situated side (FIG. 2) with respect to the supplying apparatus 2, to be removed via a removal apparatus 3.

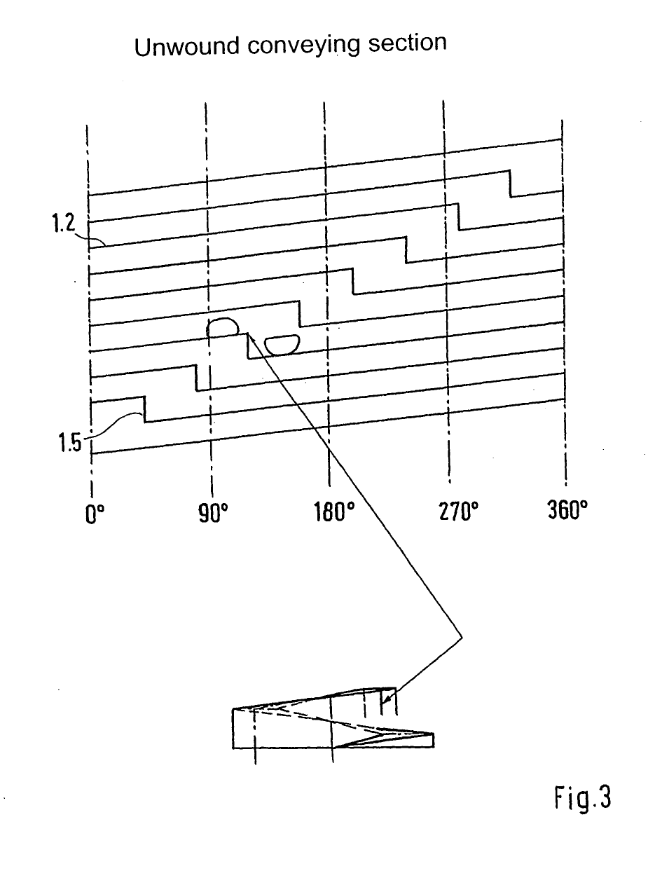

The conveying unit 1 includes a helical face 1.2, which is wound about a hollow cylindrical central section 1.3 and, as shown in FIG. 3, has a plurality of turning steps 1.5. An oscillating drive 1.1 is disposed in the lower region of the conveying unit underneath the helical face 1.2 in order to make the helical face carry out vibration movements that convey the baking products upwards. The oscillating drive 1.1, in this case has, for example, two drive units, which include imbalances rotating about a respective axis, wherein the vectors of the power components generated by the imbalances are aligned, inclined one to another and, for example, at the same angle relative to the vertical in order to effect the desired forward conveyance over the helical face 1.2. Magnetic vibrators would also be conceivable. With the coordination of the steps with the characteristics of the baking products, with the vibratory movements and with the inclination of the helical face 1.2, the baking products are turned when passing over the steps and are conveyed in the desired position until the next step where they are again turned. A plurality of steps, for example between two and ten steps or where desired even fewer, can be provided per revolution about, for example, 400° of the helical face 1.2.

The conveying unit 1 is also used for heating-up the baking products, wherein the hot air is conducted downwards by a heating apparatus 4, which is situated for example up above, in a recirculating air heating circuit 1.4 over the helical face 1.2 and is then conducted through the interior of the central section 1.3 back upwards.

As shown in FIGS. 1A to 1D, the supplying apparatus 2 includes various supplying sections, including one supplying section 2.3 which is connected to the inlet chamber 1.6, to which supplying section 2.3 uncooked baking products can be supplied from a loading unit 2.4 and/or from an individual loading section 2.1 for example via a thereto connected turning section 2.2. The individual loading section 2.1, in this case, is disposed, for example, on a rear side of the conveying apparatus oppositely situated to a removal apparatus 3.3 for the finished baking products and it enables, according to the wishes of an operator or a customer, various baking products to be locked into a baking process according to type and number.

The loading unit 2.4 is, for example, configured in the form of a pivotable supplying container, which for loading purposes is pivotable into a horizontal position and for supplying the filled-in uncooked baking products is pivotable into a position inclined relative to the supplying section 2.3. The supplying of the uncooked baking products out of the loading unit 2.4 to the supplying section 2.3 is effected by gravity via the inclination and additionally by vibration, such that cold, uncooked baking products which are still frozen are conveyed to the supplying section 2.3 securely and already singled-out to a certain degree and then, with further singling-out by chicanes or deflectors, are conveyed from the supplying section 2.3 to the conveying unit 1. The supplying section 2 also has, in an advantageous manner, an oscillating drive, a magnetic vibrating means being suitable for this at this point. The supply from the individual loading section 2.1 via the turning section 2.2 can be effected in a corresponding manner using an oscillating drive or, for example, by a circulating belt. A circulating conveyor belt is also possible as an alternative for the supplying section 2.3.

The removal apparatus 3, which is disposed above the supplying apparatus 2, includes a removal section 3.1 which, for example, can also have an oscillating drive or a circulating conveyor belt. An output section 3.2, which descends inclinedly forwards and terminates in the removal apparatus 3.3, is connected to the removal section 3.1, for example, over the overall length of the same in the design shown, which corresponds to the width of the overall removal apparatus 3 and also the supplying apparatus 2. At the removal apparatus 3.3, a customer, for example, can remove finished baking products by a suitable connected container. The removal section 3.1 can have a singling-out apparatus, which is coupled to sensors, so that different baking products can be sorted out and supplied to associated removal places, as shown in FIG. 1A.

Through the disposition of the removal apparatus 3 above the supplying apparatus 2, the heat of the baking products situated on the output section 3.2 can be used to heat the uncooked baking products situated in the loading unit 2.4.

In the embodiment shown in FIG. 2, the supplying apparatus 2 and the removal apparatus 3 are disposed on two oppositely situated sides of the conveying unit 1. For the remainder, the design can be carried out in a similar manner to the embodiment shown in FIGS. 1A to 1D.

1. A conveying apparatus for baking products, where a conveying unit (1), connected to a heating device is connected at one side to a supply apparatus (2) and at an other side to a removal apparatus (3), the conveying apparatus comprising: the conveying unit (1) including a helical face (1.2) settable to vibrate by an oscillating drive (1.1) to convey the baking products upwards, and the supply apparatus (2) connected in a lower region of the conveying unit (1) and the removal apparatus (3) connected in an upper region of the conveying unit (1).

2. The conveying apparatus according to claim 1, wherein the helical face (1.2) is wound in a concentric manner about a hollow central section (1.3).

3. The conveying apparatus according to claim 2, wherein the central section (1.3) is included in a recirculating air heating circuit (1.4) which leads over the helical face (1.2) for heating the baking products.

4. The conveying apparatus according to claim 3, wherein the helical face (1.2) includes steps (1.5) for turning the baking products when conveyed.

5. The conveying apparatus according to claim 4, wherein the oscillating drive (1.1) includes two out-of-balance drive units having power vectors aligned and inclined to a vertical and inclined to one another.

6. The conveying apparatus according to claim 5, wherein the removal apparatus (3) is disposed above the supply apparatus (2) on a same side of the conveying unit (1).

7. The conveying apparatus according to claim 6, wherein the supply apparatus (2) includes a supply section (2.3), connected to the conveying unit (1) and which has a singling-out function, and a loading unit (2.4) which leads downwards to the supply section (2.3) and is set at an incline or is adjustable at an incline relative to the supply section (2.3).

8. The conveying apparatus according to claim 7, wherein for supplying the baking products, the loading unit (2.4) is driveable by a supply drive (2.5) and the supply section (2.3) is drivable by an additional supply drive.

9. The conveying apparatus according to claim 8, wherein the supply apparatus (2) has an individual loading section (2.1) connected to the supply section (2.3).

10. The conveying apparatus according to claim 9, wherein the removal apparatus (3) includes a removal section (3.1), connected to the upper region of the helical face (1.2) and an output section (3.2), leading inclinedly downwards to a removal apparatus (3.3).

11. The conveying apparatus according to claim 10, wherein heat of the baking products situated in the removal apparatus (3) is conducted in part to the baking products in the supply apparatus (2).

12. The conveying apparatus according to claim 1, wherein the helical face (1.2) includes steps (1.5) for turning the baking products when conveyed.

13. The conveying apparatus according to claim 1, wherein the oscillating drive (1.1) includes two out-of-balance drive units having power vectors aligned and inclined to a vertical and inclined to one another.

14. The conveying apparatus according to claim 1, wherein the removal apparatus (3) is disposed above the supply apparatus (2) on a same side of the conveying unit (1).

15. The conveying apparatus according to claim 1, wherein the supply apparatus (2) includes a supply section (2.3) connected to the conveying unit (1) and which has a singling-out function, and a loading unit (2.4) which leads downwards to the supply section (2.3) and is set at an incline or is adjustable at an incline relative to the supply section (2.3).

16. The conveying apparatus according to claim 15, wherein for supplying the baking products, the loading unit (2.4) is driveable by a supply drive (2.5) and the supply section (2.3) is drivable by an additional supply drive.

17. The conveying apparatus according to claim 1, wherein the supply apparatus (2) has an individual loading section (2.1) connected to the supply section (2.3).

18. The conveying apparatus according to claim 1, wherein the removal apparatus (3) includes a removal section (3.1) connected to the upper region of the helical face (1.2) and an output section (3.2) leading inclinedly downwards to a removal apparatus (3.3).

19. The conveying apparatus according to claim 6, wherein heat of the baking products situated in the removal apparatus (3) is conducted in part to the baking products in the supply apparatus (2).
